(19) United States
(12) Patent Application Publication
(10) Pub. No.: US 2013/0335697 A1
(43) Pub. Date: Dec. 19, 2013

(54) CONTACT LENS WITH LIQUID-IMPREGNATED SURFACE

(71) Applicant: Massachusetts Institute of Technology, Cambridge, MA (US)

(72) Inventors: J. David Smith, Cambridge, MA (US); Rajeev Dhiman, Malden, MA (US); Adam T. Paxson, Cambridge, MA (US); Christopher J. Love, Atlantis, FL (US); Brian R. Solomon, Rockville, MD (US); Kripa K. Varanasi, Lexington, MA (US)

(21) Appl. No.: 13/902,689

(22) Filed: May 24, 2013

Related U.S. Application Data
(60) Provisional application No. 61/651,541, filed on May 24, 2012.

(51) Int. Cl. G02C 7/04

(52) U.S. Cl. CPC G02C 7/049
USPC 351/159.04

(57) ABSTRACT

Described herein is a contact lens with high lubricity to eye tissue/fluid and inhibited nucleation on its surface. The contact lens has a surface textured to form a matrix of micro-scale and/or nano-scale solid (e.g., gel) features spaced sufficiently close to stably contain an impregnating liquid therebetween. The impregnating liquid fills spaces between the solid features, the surface stably contains the impregnating liquid between the solid features, and the impregnating liquid is substantially held in place between the plurality of solid features regardless of orientation of the surface and despite contact with the eye tissue during normal wear, insertion, and removal of the contact lens.

### RELATED APPLICATIONS

This application claims priority to and the benefit of, and incorporates herein by reference in its entirety, U.S. Provisional Patent Application No. 61/651,541, which was filed on May 24, 2012.

### TECHNICAL FIELD

This invention relates generally to liquid-impregnated surfaces. More particularly, in certain embodiments, the invention relates to contact lenses with liquid-impregnated surfaces.

### BACKGROUND

The advent of micro/nano-engineered surfaces in the last decade has opened up new techniques for enhancing a wide variety of physical phenomena in thermofluids sciences. For example, the use of micro/nano surface textures has provided nonwetting surfaces capable of achieving less viscous drag, reduced adhesion to ice and other materials, self-cleaning, and water repellency. These improvements result generally from diminished contact (i.e., less wetting) between the solid surfaces and adjacent liquids.

Liquid-impregnated surfaces are described in U.S. patent application Ser. No. 13/302,356, published as US 2013/0032316, entitled, “Liquid-Impregnated Surfaces, Methods of Making, and Devices Incorporating the Same,” by Smith et al.; U.S. patent application Ser. No. 13/517,552, entitled, “Self-Lubricating Surfaces for Food Packaging and Food Processing Equipment,” by Smith et al.; and U.S. Provisional Patent Application No. 61/827,444, filed May 24, 2013, entitled, “Apparatus and Methods Employing Liquid-Impregnated Surfaces,” by Smith et al., the texts of which are incorporated herein by reference in their entireties.

There is a need for contact lenses with high lubricity to eye tissue and/or eye fluid, for increased comfort, reduced nucleation, and improved resistance to protein build-up and contamination.

### SUMMARY OF THE INVENTION

Described herein are contact lenses with liquid-impregnated surfaces for enhanced lubricity to eye tissue and/or eye fluid, for increased comfort, reduced nucleation, and improved resistance to protein build-up and contamination.

In one aspect, the invention provides a contact lens with high lubricity to eye tissue/fluid and/or with inhibited nucleation on its surface, the contact lens includes a surface textured to form a matrix of micro-scale and/or nano-scale solid (e.g., gel) features spaced sufficiently close to stably contain an impregnating liquid therebetween. The impregnating liquid fills spaces between the solid features. The surface may stably contain the impregnating liquid between the solid features. The impregnating liquid may be substantially held in place between the solid features regardless of orientation of the surface and despite contact with the eye tissue during normal wear, insertion, and removal of the contact lens.

In some implementations, the features define pores or cavities and the impregnating liquid fills the pores or cavities. The matrix may have a feature-to-feature spacing from about 1 micrometer to about 100 micrometers. The matrix has a feature-to-feature spacing from about 5 nanometers to about 1 micrometer. The surface is laser-etched to form said matrix of solid features. The impregnating liquid is substantially immiscible with eye fluid (e.g., substantially immiscible with a saline solution).

The solid features and/or the material of the lens itself may include one or more members selected from the group consisting of polymer, hydrogel, polyimide, polymacon, silicone hydrogel, polymethyl methacrylate (PMMA or Perspex/Plexiglas), and glass.

The solid features may include one or more members selected from the group consisting of wax, carnauba wax, beeswax, candelilla wax, zein (from corn), dextrin, cellulose ether, hydroxyethyl cellulose, hydroxypropyl cellulose (HPC), hydroxyethyl methyl cellulose, hydroxypropyl methyl cellulose (HPMC), ethyl hydroxyethyl cellulose, insoluble fiber, purified wood cellulose, micro-crystalline cellulose, kaolinite (clay mineral), Japan wax, pulp (e.g., spongy part of plant stems), ferric oxide, iron oxide, sodium formate, sodium oleate, sodium palmitate, sodium sulfate, silica, a metal, a polymer, a ceramic solid, a fluorinated solid, an intermetallic solid, and a composite solid, PDMS, cyclic olefin polymer, polypropylene, PVC, PET, and HDPE.

The impregnating liquid may include at least one member selected from the group consisting of ethyl oleate, an ester, a fatty acid, a fatty acid derivative, a terpene, an oil, tetrachloroethylene (perchloroethylene), phenyl isothiocyanate, bromobenzene, iodobenzene, o-bromotoluene, alpha-chloronaphthalene, alpha-bromonaphthalene, acetylene tetrabromide, 1-butyl-3-methylimidazolium bis(trifluoromethylsulfonyl) imide (BMIm), tribromohydrin (1,2,3-tribromopropane), ethylene dibromide, carbon disulfide, bromoform, methylene iodide (diiodomethane), stanolax, liquid petrolatum, p-bromotoluene, monobromobenzene, perchloroethylene, carbon disulfide, phenyl mustard oil, monoiodobenzene, alpha-monochloro-naphthalene, acetylene tetrabromide, aniline, butyl alcohol, isoamyl alcohol, n-heptyl alcohol, cresol, oleic acid, linoleic acid, and amyl phthalate.

In some implementations, the impregnating liquid includes a medication for delivery onto the eye.

In some implementations, the impregnating liquid is colored (e.g., for colored contact lenses).

In some implementations, the impregnating liquid forms a liquid layer extending above the top of the solid features of the surface while at equilibrium or substantially at equilibrium.

In some implementations, the liquid layer extends above the top of the solid features by at least about 5 nm.

In some implementations, one or both of the following holds: (i) 0<φ≦0.25, where φ is a representative fraction of the projected surface area of the liquid-impregnated surface corresponding to non-submerged solid at equilibrium; and (ii) S_{ow(a)}<0, where S_{ow(a)} is spreading coefficient, defined as γ_{wa}-γ_{wo}-γₒₐ, where γ is the interfacial tension between the two phases designated by subscripts w, a, and o, where w is water, a is air, and o is the impregnating liquid.

In some implementations, one or both of the following holds: (i) 0<φ≦25, where φ is a representative fraction of the projected surface area of the liquid-impregnated surface corresponding to non-submerged solid at equilibrium; and (ii) S_{ow(a)}<0, where S_{ow(a)} is spreading coefficient, defined as γ_{wa}-γ_{wo}-γₒₐ, where γ is the interfacial tension between the two phases designated by subscripts w, a, and o, where w is water, a is air, and o is the impregnating liquid. In some implementations, 0<φ≦0.25. In some implementations, 0<φ≦0.10. In some implementations, 0.01<φ≦0.25. In some implementations, 0.01<φ≦0.10. In some implementations, S_{ow(a)}<0.

In some implementations, one or both of the following holds: (i) θ_{os(w),receding}=0; and (ii) θ_{os(a),receding}=0 and θ_{os(w),receding}=0, where θ_{os(w),receding} is receding contact angle of the impregnating liquid (e.g., oil, subscript ‘o’) on the surface (subscript ‘s’) in the presence of water (subscript ‘w’), and where θ_{os(a),receding} is receding contact angle of the impregnating liquid (e.g., oil, subscript ‘o’) on the surface (subscript ‘s’) in the presence of air (subscript ‘a’).

### BRIEF DESCRIPTION OF THE DRAWINGS

The objects and features of the invention can be better understood with reference to the drawing described below, and the claims.

FIG. 1 illustrates a schematic cross-sectional view and corresponding top view of a liquid-impregnated surface that is partially submerged.

FIGS. 2A and 2B illustrates the appearance and transparency of a liquid-impregnated surface coated contact lens compared to an uncoated contact lens.

### DETAILED DESCRIPTION

It is contemplated that compositions, mixtures, systems, devices, methods, and processes of the claimed invention encompass variations and adaptations developed using information from the embodiments described herein. Adaptation and/or modification of the compositions, mixtures, systems, devices, methods, and processes described herein may be performed by those of ordinary skill in the relevant art.

Throughout the description, where articles, devices, apparatus and systems are described as having, including, or comprising specific components, or where processes and methods are described as having, including, or comprising specific steps, it is contemplated that, additionally, there are articles, devices, apparatus and systems of the present invention that consist essentially of, or consist of, the recited components, and that there are processes and methods according to the present invention that consist essentially of, or consist of, the recited processing steps.

Similarly, where articles, devices, mixtures, apparatus and compositions are described as having, including, or comprising specific compounds and/or materials, it is contemplated that, additionally, there are articles, devices, mixtures, apparatus and compositions of the present invention that consist essentially of, or consist of, the recited compounds and/or materials.

It should be understood that the order of steps or order for performing certain actions is immaterial so long as the invention remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim.

Described herein are surfaces comprising an impregnating liquid and a plurality of micro-scale and/or nano-scale solid features spaced sufficiently close to stably contain the impregnating liquid therebetween, wherein the impregnating liquid fills spaces between the solid features, wherein the interior surface stably contains the impregnating liquid between the solid features, and wherein the impregnating liquid is substantially held in place between the plurality of solid features.

In certain embodiments, the solid features may be part of the surface itself (e.g., the surface may be etched or otherwise textured to create the solid features), or the solid features may be applied to the surface. In certain embodiments, the solid features include an intrinsically hydrophobic, oleophobic, and/or metallophobic material or coating. For example, the solid features may be made of: hydrocarbons, such as alkanes, and fluoropolymers, such as teflon, trichloro(1H,1H,2H,2H-perfluorooctyl)silane (TCS), octadecyltrichlorosilane (OTS), heptadecafluoro-1,1,2,2-tetrahydrodecyltrichlorosilane, fluoroPOSS, and/or other fluoropolymers. Additional possible materials include: ceramics, polymeric materials, fluorinated materials, intermetallic compounds, and composite materials. Polymeric materials may include, for example, polytetrafluoroethylene, fluoroacrylate, fluoroeurathane, fluorosilicone, fluorosilane, modified carbonate, chlorosilanes, silicone, polydimethylsiloxane (PDMS), and/or combinations thereof. Ceramics may include, for example, titanium carbide, titanium nitride, chromium nitride, boron nitride, chromium carbide, molybdenum carbide, titanium carbonitride, electroless nickel, zirconium nitride, fluorinated silicon dioxide, titanium dioxide, tantalum oxide, tantalum nitride, diamond-like carbon, fluorinated diamond-like carbon, and/or combinations thereof. Intermetallic compounds may include, for example, nickel aluminide, titanium aluminide, and/or combinations thereof.

The solid features of a liquid-impregnated surface may form physical textures or surface roughness. The textures may be random, including fractal, or patterned. In certain embodiments, the textures are micro-scale or nano-scale features. For example, the textures may have a length scale L (e.g., an average pore diameter, or an average protrusion height) that is less than about 100 microns, less than about 10 microns, less than about 1 micron, less than about 0.1 microns, or less than about 0.01 microns. In certain embodiments, the texture includes posts or other protrusions, such as spherical or hemispherical protrusions. Rounded protrusions may be preferable to avoid sharp solid edges and minimize pinning of liquid edges. The texture may be introduced to the surface using any conventional method, including mechanical and/or chemical methods.

In certain embodiments, the solid features include particles. In certain embodiments, the particles have an average characteristic dimension in a range, for example, of about 5 microns to about 500 microns, or about 5 microns to about 200 microns, or about 10 microns to about 50 microns. In certain embodiments, the characteristic dimension is a diameter (e.g., for roughly spherical particles), a length (e.g., for roughly rod-shaped particles), a thickness, a depth, or a height. In certain embodiments, the particles include insoluble fibers, purified wood cellulose, micro-crystalline cellulose, oat bran fiber, kaolinite (clay mineral), Japan wax (obtained from berries), pulp (spongy part of plant stems), ferric oxide, iron oxide, sodium formate, sodium oleate, sodium palmitate, sodium sulfate, wax, carnauba wax, beeswax, candelilla wax, zein (from corn), dextrin, cellulose ether, Hydroxyethyl cellulose, Hydroxypropyl cellulose (HPC), Hydroxyethyl methyl cellulose, Hydroxypropyl methyl cellulose (HPMC), and/or Ethyl hydroxyethyl cellulose. In certain embodiments, the particles include a wax. In certain embodiments, the particles are randomly spaced. In certain embodiments, the particles are arranged with average spacing of about 1 micron to about 500 microns, or from about 5 microns to about 200 microns, or from about 10 microns to about 30 microns between adjacent particles or clusters of particles. In certain embodiments, the particles are spray-deposited (e.g., deposited by aerosol or other spray mechanism).

In some embodiments, micro-scale features are used. In some embodiments, a micro-scale feature is a particle. Particles can be randomly or uniformly dispersed on a surface. Characteristic spacing between particles can be about 200 μm, about 100 μm, about 90 μm, about 80 μm, about 70 μm, about 60 μm, about 50 μm, about 40 μm, about 30 μm, about 20 μm, about 10 μm, about 5 μm, or 1 μm. In some embodiments, characteristic spacing between particles is in a range of 100 μm, to 1 μm, 50 μm, to 20 μm, or 40 μm, to 30 μm. In some embodiments, characteristic spacing between particles is in a range of 100 μm, to 80 μm, 80 μm, to 50 μm, 50 μm, to 30 μm, or 30 μm, to 10 μm. In some embodiments, characteristic spacing between particles is in a range of any two values above.

Particles can have an average dimension of about 200 μm, about 100 μm, about 90 μm, about 80, about 70 μm, about 60 μm, about 50 μm, about 40 μm, about 30 μm, about 20 μm, about 10 μm, about 5 μm, or 1 μm. In some embodiments, an average dimension of particles is in a range of 100 μm, to 1 μm, 50 μm, to 10 μm, or 30 μm, to 20 μm. In some embodiments, an average dimension of particles is in a range of 100 μm, to 80 μm, 80 μm, to 50 μm, 50 μm, to 30 μm, or 30 μm, to 10 μm. In some embodiments, an average dimension of particles is in a range of any two values above.

In some embodiments, particles are porous. Characteristic pore size (e.g., pore widths or lengths) of particles can be about 5000 nm, about 3000 nm, about 2000 nm, about 1000 nm, about 500 nm, about 400 nm, about 300 nm, about 200 nm, about 100 nm, about 80 nm, about 50, about 10 nm. In some embodiments, characteristic pore size is in a range of 200 nm to 2 μm, or 100 nm to 1 μm. In some embodiments, characteristic pore size is in a range of any two values above.

The impregnating liquid of a liquid-impregnating surface may be oil-based or water-based (i.e., aqueous). The liquid may be chosen for a given application based on its properties. In certain embodiments, the impregnating liquid is an ionic liquid (e.g., BMI-IM). Other examples of possible impregnating liquids include hexadecane, vacuum pump oils (e.g., FOMBLIN® 06/6, KRYTOX® 1506) silicon oils (e.g., 10 cSt or 1000 cSt), fluorocarbons (e.g., perfluoro-tripentylamine, FC-70), shear-thinning fluids, shear-thickening fluids, liquid polymers, dissolved polymers, viscoelastic fluids, and/or liquid fluoroPOSS. In one embodiment, the impregnating liquid is made shear thickening with the introduction of nano particles. A shear-thickening impregnating liquid may be desirable for preventing impalement and resisting impact from impinging liquids, for example. To minimize evaporation of the impregnating liquid from the surface, it may be desirable to use an impregnating liquid that has a low vapor pressure (e.g., less than 0.1 mmHg, less than 0.001 mmHg, less than 0.00001 mmHg, or less than 0.000001 mmHg). In certain embodiments, the impregnating liquid has a freezing point of less than −20° C., less than −40° C., or about −60° C. In certain embodiments, the surface tension of the impregnating liquid is about 15 mN/m, about 20 mN/m, or about 40 mN/m. In certain embodiments, the viscosity of the impregnating liquid is from about 10 cSt to about 1000 cSt.

The impregnating liquid may be introduced to the surface using a conventional technique for applying a liquid to a solid. In certain embodiments, a coating process, such as a dip coating, blade coating, or roller coating, is used to apply the impregnating liquid. Alternatively, the impregnating liquid may be introduced and/or replenished by liquid materials flowing past the surface. In preferred embodiments, after the impregnating liquid has been applied, capillary forces hold the liquid in place.

In certain embodiments, a texture may be applied to a substrate to form a surface with solid features. Applying the texture may include: exposing the substrate to a solvent (e.g., solvent-induced crystallization), extruding or blow-molding a mixture of materials, roughening the substrate with mechanical action (e.g., tumbling with an abrasive), spray-coating, polymer spinning, depositing particles from solution (e.g., layer-by-layer deposition and/or evaporating away liquid from a liquid and particle suspension), extruding or blow-molding a foam or foam-forming material (e.g., a polyurethane foam), depositing a polymer from a solution, extruding or blow-molding a material that expands upon cooling to leave a wrinkled or textured surface, applying a layer of material onto a surface that is under tension or compression, performing non-solvent induced phase separation of a polymer to obtain a porous structure, performing micro-contact printing, performing laser rastering, performing nucleation of the solid texture out of vapor (e.g., desublimation), performing anodization, milling, machining, knurling, e-beam milling, performing thermal or chemical oxidation, and/or performing chemical vapor deposition. In certain embodiments, applying the texture to the substrate includes spraying a mixture of edible particles onto the substrate. In certain embodiments, impregnating the matrix of features with the liquid includes: spraying the encapsulating liquid onto the matrix of features, brushing the liquid onto the matrix of features, submerging the matrix of features in the liquid, spinning the matrix of features, condensing the liquid onto the matrix of features, depositing a solution comprising the liquid and one or more volatile liquids, and/or spreading the liquid over the surface with a second immiscible liquid. In certain embodiments, the liquid is mixed with a solvent and then sprayed, because the solvent will reduce the liquid viscosity, allowing it to spray more easily and more uniformly. Then, the solvent will dry out of the coating. In certain embodiments, the method further includes chemically modifying the substrate prior to applying the texture to the substrate and/or chemically modifying the solid features of the texture. For example, the method may include chemically modifying with a material having contact angle with water of greater than 70 degrees (e.g., hydrophobic material). The modification may be conducted, for example, after the texture is applied, or may be applied to particles prior to their application to the substrate. In certain embodiments, impregnating the matrix of features includes removing excess liquid from the matrix of features. In certain embodiments, removing the excess liquid includes: using a second immiscible liquid to carry away the excess liquid, using mechanical action to remove the excess liquid, absorbing the excess liquid using a porous material, and/or draining the excess liquid off of the matrix of features using gravity or centrifugal forces.

Liquid-impregnated surfaces are useful for reducing viscous drag between a solid surface and a flowing liquid. In general, the viscous drag or shear stress exerted by a liquid flowing over a solid surface is proportional to the viscosity of the liquid and the shear rate adjacent to the surface. A traditional assumption is that liquid molecules in contact with the solid surface stick to the surface, in a so-called “no-slip” boundary condition. While some slippage may occur between the liquid and the surface, the no-slip boundary condition is a useful assumption for most applications. In certain embodiments, liquid-impregnated surfaces are desirable as they induce a large amount of slip at the solid surface. Drag reductions of as much as 40% may be achieved due to this slippage.

In certain embodiments, impregnating a liquid within the textures of a liquid-impregnated surface prevents or reduces nucleation in these regions. The reduction in nucleation is enhanced where liquid covers the tops of the solid features of the liquid-impregnated surface. Furthermore, in certain embodiments, liquid-impregnated surfaces have low roll-off angles (i.e., the angle or slope of a surface at which a droplet in contact with the surface will begin to roll or slide off the surface). The low roll-off angles associated with liquid-impregnated surfaces allow droplets in contact with the surface to easily roll off the surface before the liquid can accumulate on the surface. In certain embodiments, liquid-impregnated surfaces are used to provide hydrate-phobicity, thereby preventing or minimizing the formation of hydrates. In certain embodiments, liquid-impregnated surfaces are used to provide salt-phobicity, thereby preventing or minimizing the formation of salts or mineral scale.

In certain embodiments, liquid-impregnated surfaces are used to reduce viscous drag between a solid surface and a flowing liquid. In certain embodiments, a liquid-impregnated surface is used to provide lubrication between the liquid-impregnated surface and a substance in contact with the surface (or the surface itself, where one liquid-impregnated surface rubs against another liquid-impregnated surface, or parts of the liquid-impregnated surface rub against each other). For example, liquid-impregnated surfaces may provide significant slip/lubrication advantages when in contact with a substance that is a non-Newtonian material, a Bingham plastic, a thixotropic fluid, and/or a shear-thickening substance.

Liquid-impregnated surfaces may also provide anti-fouling and/or self-cleaning Liquid-impregnated surfaces may also be used to promote the condensation of moisture.

As used herein, emerged area fraction φ is defined as a representative fraction of the projected surface area of (a representative fraction of) the liquid-impregnated surface corresponding to non-submerged solid at equilibrium (or pseudo-equilibrium). The term “equilibrium” as used herein refers to the condition in which the average thickness of the impregnating film does not substantially change over time due to drainage by gravity when the substrate is held away from horizontal, and where evaporation is negligible (e.g., if the liquid impregnated liquid were to be placed in an environment saturated with the vapor of that impregnated liquid). Similarly, the term “pseudo-equilibrium” as used herein refers to the same condition except that evaporation may occur.

In general, a “representative fraction” of a surface refers to a portion of the surface with a sufficient number of solid features thereupon such that the portion is reasonably representative of the whole surface. In certain embodiments, a “representative fraction” is at least a tenth of the whole surface.

In certain embodiments, φ is zero (there is a layer of liquid over the top of the solid features which may be, for example, at least 1 nm, at least 5 nm, at least 10 nm, or at least 100 nm in thickness). In certain embodiments of the present invention, φ is less than 0.30, 0.25, 0.20, 0.15, 0.10, 0.05, 0.01, or 0.005. In certain embodiments, φ is greater than 0.001, 0.005, 0.01, 0.05, 0.10, 0.15, or 0.20. In certain embodiments, φ is in a range of about 0 and about 0.25. In certain embodiments, φ is in a range of about 0 and about 0.01. In certain embodiments, φ is in a range of about 0.001 and about 0.25. In certain embodiments, φ is in a range of about 0.001 and about 0.10.

In some embodiments, the liquid-impregnated surface is configured such that cloaking by the impregnating liquid can be either eliminated or induced, according to different embodiments described herein.

As used herein, the spreading coefficient, S_{ow(a)} is defined as γ_{wa}-γ_{wo}-γₒₐ, where y is the interfacial tension between the two phases designated by subscripts w, a, and o, where w is water, a is air, and o is the impregnating liquid. Interfacial tension can be measured using a pendant drop method as described in Stauffer, C. E., “The measurement of surface tension by the pendant drop technique,” J. Phys. Chem. 1965, 69, 1933-1938, the text of which is incorporated by reference herein. Exemplary surfaces and its interfacial tension measurements (at approximately 25° C.) are shown in Appendix D, in particular, Table S2.

Without wishing to be bound to any particular theory, impregnating liquids that have S_{ow(a)} less than 0 will not cloak, resulting in no loss of impregnating liquids, whereas impregnating liquids that have S_{ow(a)} greater than 0 will cloak matter (condensed water droplets, bacterial colonies, solid surface) and this may be exploited to prevent corrosion, fouling, etc. In certain embodiments, cloaking is used for preventing vapor-liquid transformation (e.g, water vapor, metallic vapor, etc.). In certain embodiments, cloaking is used for inhibiting liquid-solid formation (e.g., ice, metal, etc.). In certain embodiments, cloaking is used to make reservoirs for carrying the materials, such that independent cloaked materials can be controlled and directed by external means (like electric or magnetic fields).

In certain embodiments, lubricant cloaking is desirable and is used a means for preventing environmental contamination, like a time capsule preserving the contents of the cloaked material. Cloaking can result in encasing of the material thereby cutting its access from the environment. This can be used for transporting materials (such as bioassays) across a length in a way that the material is not contaminated by the environment.

In certain embodiments, the amount of cloaking can be controlled by various lubricant properties such as viscosity, surface tension. Additionally or alternatively, we can control the de-wetting of the cloaked material to release the material. Thus, it is contemplated that a system in which a liquid is dispensed in the lubricating medium at one end, and upon reaching the other end is exposed to environment that causes the lubricant to uncloak.

In some embodiments, an impregnating liquid can be selected to have a S_{ow(a)} less than 0. Exemplary impregnating liquids include, but are not limited to, tetrachloroethylene (perchloroethylene), phenyl isothiocyanate (phenyl mustard oil), bromobenzene, iodobenzene, o-bromotoluene, alpha-chloronaphthalene, alpha-bromonaphthalene, acetylene tetrabromide, 1-butyl-3-methylimidazolium bis(trifluoromethylsulfonyl) imide (BMIm), tribromohydrin (1,2,3-tribromopropane), tetradecane, cyclohexane, ethylene dibromide, carbon disulfide, bromoform, methylene iodide (diiodomethane), stanolax, Squibb's liquid petrolatum, p-bromotoluene, monobromobenzene, perchloroethylene, carbon disulfide, phenyl mustard oil, monoiodobenzene, alpha-monochloro-naphthalene, acetylene tetrabromide, aniline, butyl alcohol, isoamyl alcohol, n-heptyl alcohol, cresol, oleic acid, linoleic acid, amyl phthalate and any combination thereof.

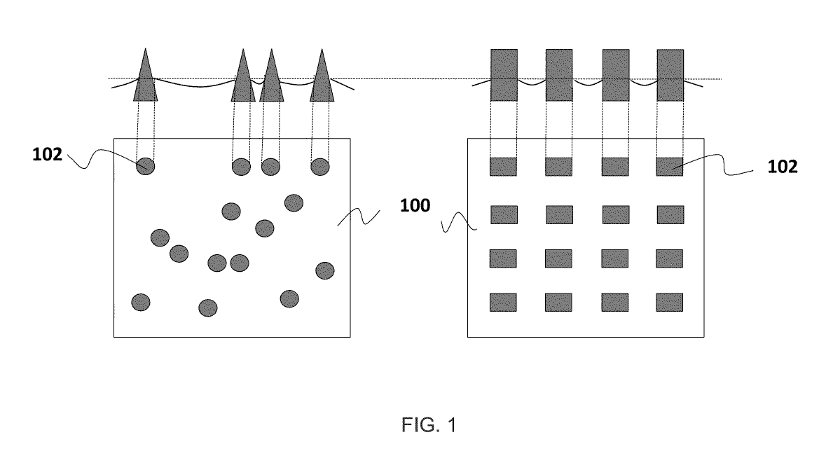

Referring to FIG. 1, a schematic cross-sectional view and the corresponding top view of a liquid-impregnated surface that is partially submerged is shown. The upper left drawing of FIG. 1 shows a cross-sectional view of a row of cone-shaped solid features. The projected surface area of the non-submerged solid 102 is illustrated as shaded areas of the overhead view, while the remaining non-shaded area represents the projected surface area of the submerged liquid-impregnated surface 100. In addition to the projection surface area of this row of solid features, other solid features placed in a semi-random pattern are shown in shade in the overhead view. Similarly, the cross-section view of a row of evenly spaced posts is shown on the right of FIG. 1. Additional rows of well-patterned posts are shown in shade in the overhead view. As demonstrated, in some embodiments of the present invention, a liquid-impregnated surface includes randomly and/or non-randomly patterned solid features.

The impregnating liquid fills the spaces between the solid features, and the surface stably holds the impregnating liquid in place in between the solid features regardless of the orientation of the surface. In some implementations, the particles have an average dimension of 5 microns to 50 microns. In some implementations, the particles are arranged with average spacing of about 10 microns to about 30 microns between adjacent particles or clusters of particles.

In some embodiments, the liquid-impregnated surface is created by applying a uniform layer of the impregnating liquid to any surface. This surface may be the surface of a contact lens. Liquid encapsulated surfaces could be applied to a contact lens to improve the comfort on the wearer. Liquid encapsulated surfaces would also help contact lenses retain moisture and maintain a tear film within the eye to prevent dry eye symptoms including burning, stinging, redness, foreign body sensation, excess tearing, and intermittent blurred vision, and reduce potential scratching of the eye.

Currently, the lifetime of disposable contact lenses is two weeks on average. Liquid encapsulated surfaces may extend the lifetime of current disposable contact lenses substantially. The retained liquid interface between the contact lens and the eye would help reduce contact lens wear and tear, thereby improving the contact lens's lifetime. The liquid encapsulated surfaces may allow the contact lenses to be worn overnight and for periods of longer than two weeks.

In some embodiments, liquid encapsulated surfaces may also reduce contact lens maintenance. Currently rewetting drop products such as “Refresh Contacts”, “Clerz Plus”, or “Clear Eyes Contact Lens Relief” moistens contact lenses and removes particles accrued on the contact lens that cause irritation and discomfort. However, these rewetting drops will not be needed as frequently with liquid encapsulated surfaced contact lenses since the liquid encapsulated surfaces will retain moisture and prevent dry eyes. Current contact lenses require soaking in a saline solution nightly to moisturize the contact lens. Such a nightly soaking may not be necessary due to the liquid encapsulated surface present in the improved contact lenses.

In some embodiments, the contact lenses may have texture or roughness on one or both sides of the lens, or porosity extending all the way through the lens. The liquid to be housed in the liquid layer of the lens could be applied to one or both sides of the lens. Alternatively, the liquid could be soaked all the way through the lens. The liquid may be applied and reapplied by the user after purchase multiple times.

In some embodiments, the contact lens is constructed from polyimide. The texture can be controlled or adjusted via a temperature- or solvent-induced crystallization of the polymer surface of polyimide to form spherulites or other fine microstructures. Many polymers already used in the manufacture of contact lenses undergo spherulitic crystallization.

The solid and liquid materials may be chosen from materials already deemed safe by the United States Food and Drug Administration for contact with the eye. The liquid could be immiscible with eye fluid and the eye fluid may act as the supply to the textures.

In some embodiments, the solid features and the material of the lens itself may be polymer, hydrogel, polyimide, polymacon, silicone hydrogel, polymethyl methacrylate (PMMA or Perspex/Plexiglas) or any combination of these materials.

In some embodiments, optical clarity could be achieved either by having features smaller than 100 nm or by matching the refractive index of the texture material and the liquid. The liquid and texture would ideally be transparent, or translucent, but thin enough so that the effective transmissivity within the visible spectrum is at least 95%.

In some embodiments, the impregnating liquid in the liquid layer is colored. The colored impregnating provides the color for colored contact lenses.

In some embodiments, the impregnating liquid forms a liquid layer extending above the top of the solid features of the surface while at equilibrium or substantially at equilibrium. In some embodiments, the liquid layer extends above the top of the solid features by at least about 5 nm.

In some embodiments, current laser etching techniques, such as CO2 or Deep UV, can be adapted to generate patterned and textured surfaces across the entire interior surface of the contact lens. Current laser etching techniques only create small identification marks on the inside of a contact lens. The laser techniques may be expanded to provide a patterned textured with uniform dimensions across the entire contact lens. Impregnating this textured surface with a liquid with the same or almost the same refractive index as the contact lens material would cause the contact lens to become transparent. An example experiment discussed below compares the transparency of a contact lens with a liquid encapsulated surface to that of a conventional uncoated contact lens.

### EXPERIMENTAL EXAMPLE

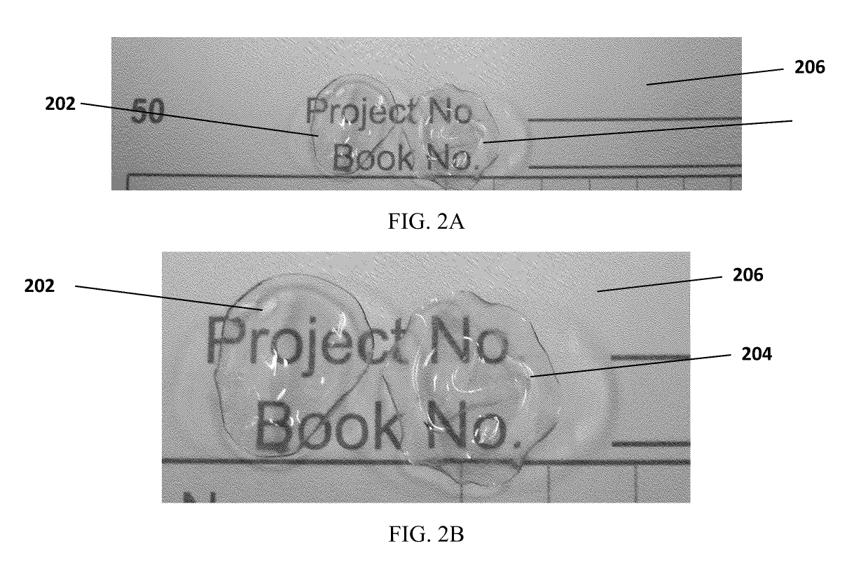

FIGS. 2A and 2B show experimental measurements of transparency of a contact lens with a liquid encapsulated surface when compared to that of a conventional uncoated contact lens.

Two Acuve Oasys contact lenses having a base curve radius of 8.4 millimeters, diameter of 14 millimeters and a power of −0.75 diopters were used for this experiment, labeled lens 202 and lens 204. Lenses 202 and 204 were dipped in saline solution. Using tweezers, lenses 202 and 204 were removed from saline solution and were blow dried with nitrogen gas. Carnuba wax suspension was sprayed onto the interior and exterior surfaces of lens 204 while holding the lens 204 at least twelve inches away from the spray nozzle to minimize spray force on the lenses and achieve uniform coating. Subsequently, nitrogen gas was blown across the lens 204 to allow time to dry coating prior to application of ethyl oleate. Subsequently, ethyl oleate was sprayed onto the interior and exterior surfaces of lens 204 while holding the lens 204 at least twelve inches away from the spray nozzle to minimize spray force on the lenses and achieve uniform coating. Finally, contact lenses 202 and 204 were placed on notebook page 206 to provide background and demonstrate transparency of the coating and the photo of FIGS. 2A and 2B was taken. FIG. 2B is merely a zoomed in image of FIG. 2A.

In this experiment, contact lens 204 coated with a liquid-impregnated surface comprising carnauba wax and ethyl oleate demonstrated transparency when placed onto a notebook page 206. Words were clearly visible through the transparent coating (See FIGS. 2A and 2B).

Contact angle measurements were performed for both uncoated lens 202 and coated contact lens 204. Droplets deposited on the untreated contact lens 202 were gradually absorbed on the surface indicating that water doesn't slip over the surface. Instead, the deposited water droplets were absorbed. As the contact lens surface of lens 204 is completely covered by the impregnating liquid-impregnating surface coating, the substrate materials of lens 204 would not have a substantial effect on the roll-off angles (i.e. the slipperiness) of the surface.

Carnauba wax was applied onto a glass slide and the roll-off angles of a five microliter water droplet on the glass slide was measured to measure the coating performance. The roll-off angle was measured as using a Rame-hart goniometer. This low roll-off angle demonstrate the ease by which water, which is similar in properties to tear fluid slips over the liquid-impregnated surface.

### Equivalents

While the invention has been particularly shown and described with reference to specific preferred embodiments, it should be understood by those skilled in the art that various changes in form and detail may be made therein without departing from the spirit and scope of the invention as defined by the appended claims.

1. A contact lens with high lubricity to eye tissue/fluid and/or with inhibited nucleation on its surface, said contact lens comprising a surface textured to form a matrix of micro-scale and/or nano-scale solid (including a gel) features spaced sufficiently close to stably contain an impregnating liquid therebetween, wherein said impregnating liquid fills spaces between said solid features, wherein said surface stably contains said impregnating liquid between said solid features, and wherein said impregnating liquid is substantially held in place between said plurality of solid features regardless of orientation of said surface and despite contact with said eye tissue during normal wear, insertion, and removal of said contact lens.

2. The contact lens of claim 1, wherein the features define pores or cavities and wherein the impregnating liquid fills the pores or cavities.

3. The contact lens of claim 1, wherein the matrix has a feature-to-feature spacing from about 1 micrometer to about 100 micrometers.

4. The contact lens of claim 1, wherein the matrix has a feature-to-feature spacing from about 5 nanometers to about 1 micrometer.

5. The contact lens of claim 1, wherein the surface is laser-etched to form said matrix of solid features.

6. The contact lens of claim 1, wherein the impregnating liquid is substantially immiscible with eye fluid.

7. The contact lens of claim 1, wherein the solid features and/or the material of the lens itself comprises one or more members selected from the group consisting of polymer, hydrogel, polyimide, polymacon, silicone hydrogel, polymethyl methacrylate, and glass.

8. The contact lens of claim 1, wherein the solid features comprise one or more members selected from the group consisting of wax, carnauba wax, beeswax, candelilla wax, zein (from corn), dextrin, cellulose ether, hydroxyethyl cellulose, hydroxypropyl cellulose (HPC), hydroxyethyl methyl cellulose, hydroxypropyl methyl cellulose (HPMC), ethyl hydroxyethyl cellulose, insoluble fiber, purified wood cellulose, micro-crystalline cellulose, kaolinite (clay mineral), Japan wax, pulp, ferric oxide, iron oxide, sodium formate, sodium oleate, sodium palmitate, sodium sulfate, silica, a metal, a polymer, a ceramic solid, a fluorinated solid, an intermetallic solid, and a composite solid, PDMS, cyclic olefin polymer, polypropylene, PVC, PET, and HDPE.

9. The contact lens of claim 1, wherein the impregnating liquid comprises at least one member selected from the group consisting of ethyl oleate, an ester, a fatty acid, a fatty acid derivative, a terpene, an oil, tetrachloroethylene, phenyl isothiocyanate, bromobenzene, iodobenzene, o-bromotoluene, alpha-chloronaphthalene, alpha-bromonaphthalene, acetylene tetrabromide, 1-butyl-3-methylimidazolium bis(trifluoromethylsulfonyl) imide (BMIm), tribromohydrin, ethylene dibromide, carbon disulfide, bromoform, methylene iodide (diiodomethane), stanolax, liquid petrolatum, p-bromotoluene, monobromobenzene, perchloroethylene, carbon disulfide, phenyl mustard oil, monoiodobenzene, alpha-monochloro-naphthalene, acetylene tetrabromide, aniline, butyl alcohol, isoamyl alcohol, n-heptyl alcohol, cresol, oleic acid, linoleic acid, and amyl phthalate.

10. The contact lens of claim 1, wherein the impregnating liquid comprises a medication for delivery onto the eye.

11. The contact lens of claim 1, wherein the impregnating liquid is colored (including wherein the impregnating liquid is colored for colored contact lenses).

12. The contact lens of claim 1, wherein the impregnating liquid forms a liquid layer extending above the top of the solid features of the surface while at equilibrium or substantially at equilibrium.

13. The contact lens of claim 12, wherein the liquid layer extends above the top of the solid features by at least about 5 nm.

14. The contact lens of claim 1, wherein one or both of the following holds:
(i) 0<φ≦0.25, where is a representative fraction of the projected surface area of the liquid-impregnated surface corresponding to non-submerged solid at equilibrium; and
(ii) S_{ow(a)}<0, where S_{ow(a)} is spreading coefficient, defined as γ_{wa}-γ_{wo}-γₒₐ, where γ is the interfacial tension between the two phases designated by subscripts w, a, and o, where w is water, a is air, and o is the impregnating liquid.

15. The contact lens of claim 14, wherein 0<φ≦0.25.

16. The contact lens of claim 14, wherein 0<φ≦0.10.

17. The contact lens of claim 14, wherein 0.01<φ≦0.25.

18. The contact lens of claim 14, wherein 0.01<φ≦0.10.

19. The contact lens of claim 14, wherein S_{ow(a)}<0.

20. The contact lens of claim 1, wherein one or both of the following holds:
(i) θ_{os(w),receding}=0; and
(ii) θ_{os(a),receding}=0 and θ_{os(w),receding}=0
where θ_{os(w),receding}=0 is receding contact angle of the impregnating liquid (including oil, subscript ‘o’) on the surface (subscript ‘s’) in the presence of water (subscript ‘w’), and where θ_{os(a),receding} is receding contact angle of the impregnating liquid (including oil, subscript ‘o’) on the surface (subscript ‘s’) in the presence of air (subscript ‘a’).
